(19) United States
(12) Patent Application Publication
(10) Pub. No.: US 2026/0213792 A1
(43) Pub. Date: Jul. 23, 2026

(54) DIFFERENTIAL CHANNEL ESTIMATION AND SOUNDING ASSOCIATED WITH RECONFIGURABLE INTELLIGENT SURFACES

(71) Applicant: InterDigital Patent Holdings, Inc., Wilmington, DE (US)

(72) Inventors: Deepa Gurmukhdas Jagyasi, London (GB); Patrick Svedman, Stockholm (SE); Arman Shojaeifard, London (GB); Kyle Jung-Lin Pan, Saint James, NY (US); Allan Yingming Tsai, Boonton, NJ (US)

(73) Assignee: InterDigital Patent Holdings, Inc., Wilmington, DE (US)

(21) Appl. No.: 19/134,951

(22) PCT Filed: Dec. 15, 2023
(86) PCT No.: PCT/US2023/084260

§ 371 Date: Jun. 2, 2025

Related U.S. Application Data
(60) Provisional application No. 63/433,076, filed on Dec. 16, 2022.

(51) Int. Cl. H04B 7/04; H04B 7/06

(52) U.S. Cl. CPC H04B 7/04013; H04B 7/0626; H04B 7/0632; H04B 7/0639

(57) ABSTRACT

A wireless transmit/receive unit (WTRU) may receive configuration information associated with a reconfigurable intelligent surface (RIS). The configuration information may indicate a first set of RIS parameters associated with a first RIS configuration. The configuration information may indicate a second set of RIS parameters associated with a second RIS configuration. The WTRU may receive a first channel state information-reference signal (CSI-RS) associated with the first set of RIS parameters. The WTRU may receive a second CSI-RS associated with the second set of RIS parameters. The WTRU may determine, based on the first CSI-RS associated with the first set of RIS parameters and the second CSI-RS associated with the second set of RIS parameters, a differential CSI measurement associated with a base station (BS)-RIS-WTRU channel. The WTRU may send a CSI report including the differential CSI measurement.

### CROSS-REFERENCE TO RELATED APPLICATIONS

This application claims the benefit of Provisional U.S. Patent Application No. 63/433,076, filed Dec. 16, 2022, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for channel estimation related to a reconfigurable intelligent surface (RIS). In examples, a wireless transmit/receive unit (WTRU) may receive configuration information associated with an RIS. The configuration information may indicate a first set of RIS parameters associated with a first RIS configuration. The configuration information may indicate a second set of RIS parameters associated with a second RIS configuration. The WTRU may receive a first channel state information-reference signal (CSI-RS) associated with the first set of RIS parameters. The WTRU may receive a second CSI-RS associated with the second set of RIS parameters. The WTRU may determine, based on the first CSI-RS associated with the first set of RIS parameters and the second CSI-RS associated with the second set of RIS parameters, a differential CSI measurement associated with a base station (BS)-RIS-WTRU channel. The WTRU may send a CSI report including the differential CSI measurement.

In examples, the first RIS configuration may correspond to a first RIS state, and the second RIS configuration may correspond to a second RIS state. The first set of RIS parameters may represent the first RIS state. The second set of RIS parameters may represent the second RIS state. The RIS parameters may include a phase shift and/or an amplification gain. For example, the first set of RIS parameters may include a first phase shift and a first amplification gain, and the second set of RIS parameters may include a second phase shift and a second amplification gain. The first phase shift and the second phase shift may be different, and the first amplification gain and the second amplification gain may be different. In some examples, the first set of RIS parameters may represent a first RIS state of a sub-surface of the RIS, and the second set of RIS parameters may represent a second RIS state of the sub-surface of the RIS.

In examples, the WTRU may determine a first channel measurement based on the first CSI-RS and the first set of RIS parameters. The WTRU may determine a second channel measurement based on the second CSI-RS and the second set of RIS parameters. The WTRU may determine, based on the first channel measurement and the second channel measurement, the differential CSI measurement associated with the BS-RIS-WTRU channel.

In examples, the WTRU may determine, based on received configuration information, a first list of CSI-RS resource identifiers (IDs) and a second list of CSI-RS resource IDs. The first list of CSI-RS resource IDs may be associated with the first RIS configuration. The second list of CSI-RS resource IDs may be associated with the second RIS configuration. The WTRU may determine a first set of CSI-RS resources based on the first list of CSI-RS resource IDs. The WTRU may receive the first CSI-RS using one or more CSI-RS resources of the first set of CSI-RS resources. The WTRU may determine a second set of CSI-RS resources based on the second list of CSI-RS resource IDs. The WTRU may receive the second CSI-RS using one or more CSI-RS resources of the second set of CSI-RS resources.

In examples, the WTRU may determine, based on the differential CSI measurement, a rank indicator (RI) associated with the BS-RIS-WTRU channel, a precoding matrix indicator (PMI) associated with the BS-RIS-WTRU channel, and/or a channel quality indicator (CQI) associated with the BS-RIS-WTRU channel. The WTRU may determine an RI associated with a BS-WTRU channel between the WTRU and a BS, a PMI associated with the BS-WTRU channel between the WTRU and the BS, and a CQI associated with the BS-WTRU channel between the WTRU and the BS. The WTRU may report the RI, PMI, and CQI associated with the BS-RIS-WTRU channel and the RI, PMI, and CQI associated with the BS-WTRU channel.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of an RIS-aided system;

FIG. 3 illustrates example distributions of RIS elements into sub-surfaces: FIG. 3A and FIG. 3B illustrate examples of uniform distribution while FIG. 3C illustrates an example of non-uniform distribution.

FIG. 4 Illustrates an example of an RIS-aided system where an RIS is partitioned into S (e.g., S=6) sub-surfaces;

FIG. 5 illustrates an example differential channel estimation;

FIG. 6 illustrates an example signaling diagram for differential channel estimation (e.g., RIS differential channel estimation);

FIG. 7 illustrates an example signaling diagram for differential channel estimation (e.g., RIS differential channel estimation);

FIG. 8 illustrates an example of CSI-RS resources with two M size resource sets;

FIG. 9 illustrates an example of CSI-RS resources with resource sets spread in different slots;

FIG. 10 illustrates an example of CSI-RS resources occurring in multiple slots;

FIG. 11 illustrates an example of CSI-RS resources with M=1; and

FIG. 12 illustrates an example of CSI-RS resource(s) with RIS state(s).

### DETAILED DESCRIPTION

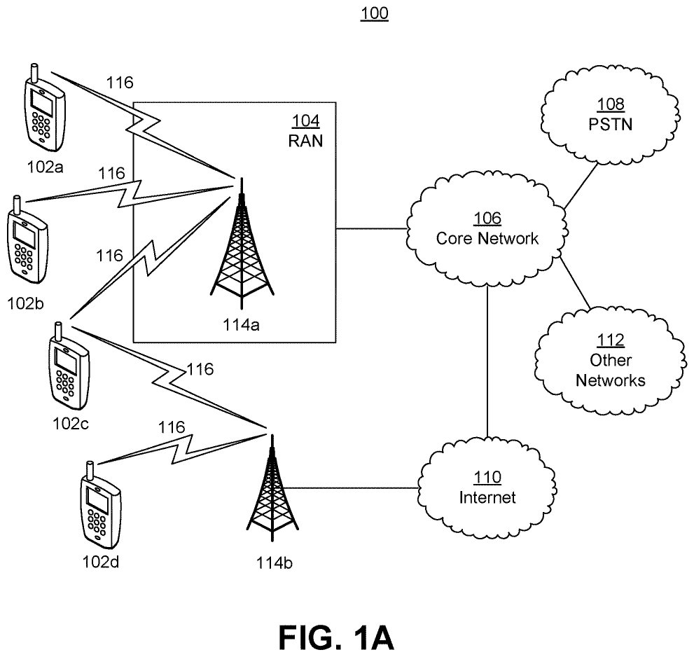

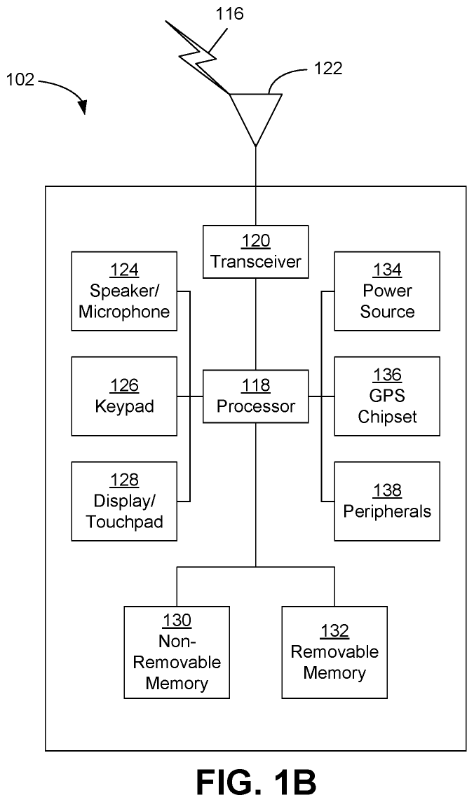

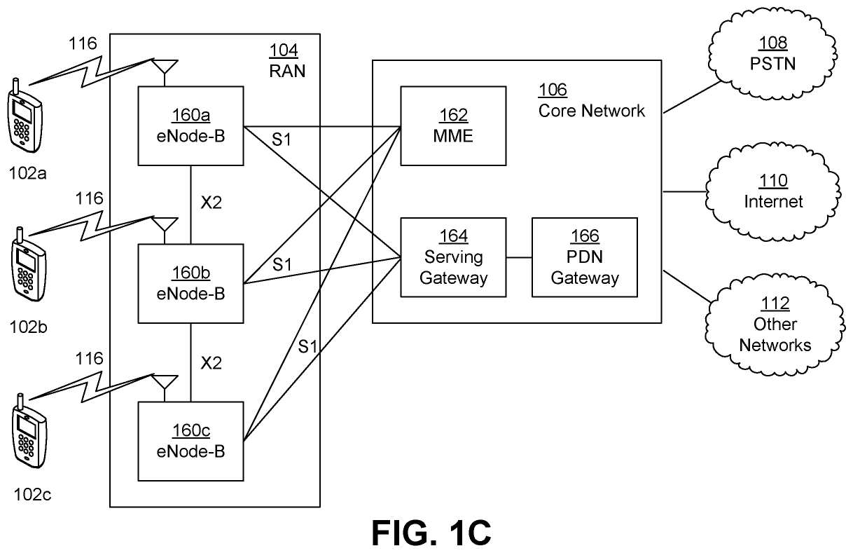

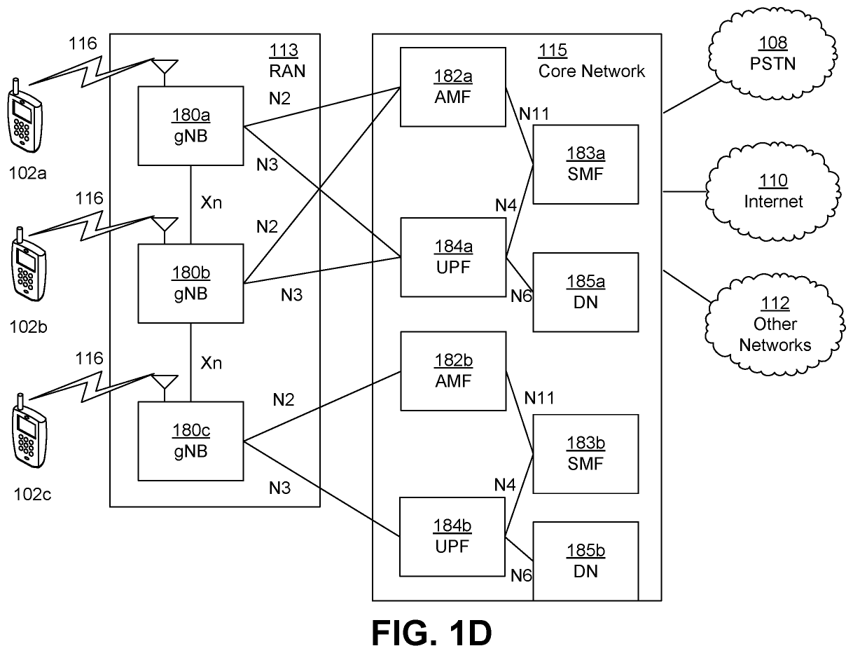

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Described herein are systems, methods, and instrumentalities associated with differential channel estimation and sounding for reconfigurable intelligent surfaces. Enhancements to WTRUs, the RIS, and/or network devices may be implemented. The enhancements may be associated with CSI acquisition, CSI-RS provision, RIS configuration, RIS control, CSI feedback or reporting, etc.

A wireless transmit receive unit (WTRU) may include a processor.

The WTRU may receive an indication of a set of channel state information reference signal (CSI-RS) resources for a set of reconfigurable intelligent surface (RIS) states. The WTRU may receive a one or more CSI-RS resources. The WTRU may measure and compute a differential channel based on one or more of the indicated set of CSI-RS resources and the one or more CSI-RS resources. The WTRU may send a message to a device, and the message may include a differential channel report corresponding to the differential channel.

The WTRU may receive, via RRC signaling, configuration information that indicates one or more of a plurality of RIS related parameters, the plurality of CSI-RS resources, and a plurality of RIS-configuration parameters.

The WTRU may receive a CSI report configuration information, wherein the differential channel report is generated at least in part based on the CSI report configuration information.

A device, such as an RIS controller, may include a processor. The device may report, to a network, the capability of the device. The device may apply a sub-surface configuration during a plurality of configured time instances. The device may receive an RIS-element level RIS state. The device may apply the RIS-element level RIS state during the configured time instances.

Systems, methods, and instrumentalities are described herein for channel estimation related to a reconfigurable intelligent surface (RIS). In examples, a wireless transmit/receive unit (WTRU) may receive configuration information associated with an RIS. The configuration information may indicate a first set of RIS parameters associated with a first RIS configuration. The configuration information may indicate a second set of RIS parameters associated with a second RIS configuration. The WTRU may receive a first channel state information-reference signal (CSI-RS) associated with the first set of RIS parameters. The WTRU may receive a second CSI-RS associated with the second set of RIS parameters. The WTRU may determine, based on the first CSI-RS associated with the first set of RIS parameters and the second CSI-RS associated with the second set of RIS parameters, a differential CSI measurement associated with a base station (BS)-RIS-WTRU channel. The WTRU may send a CSI report including the differential CSI measurement.

In examples, the first RIS configuration may correspond to a first RIS state, and the second RIS configuration may correspond to a second RIS state. The first set of RIS parameters may represent the first RIS state. The second set of RIS parameters may represent the second RIS state. The RIS parameters may include a phase shift and/or an amplification gain. For example, the first set of RIS parameters may include a first phase shift and a first amplification gain, and the second set of RIS parameters may include a second phase shift and a second amplification gain. The first phase shift and the second phase shift may be different, and the first amplification gain and the second amplification gain may be different. In some examples, the first set of RIS parameters may represent a first RIS state of a sub-surface of the RIS, and the second set of RIS parameters may represent a second RIS state of the sub-surface of the RIS.

In examples, the WTRU may determine a first channel measurement based on the first CSI-RS and the first set of RIS parameters. The WTRU may determine a second channel measurement based on the second CSI-RS and the second set of RIS parameters. The WTRU may determine, based on the first channel measurement and the second channel measurement, the differential CSI measurement associated with the BS-RIS-WTRU channel.

In examples, the WTRU may determine, based on received configuration information, a first list of CSI-RS resource identifiers (IDs) and a second list of CSI-RS resource IDs. The first list of CSI-RS resource IDs may be associated with the first RIS configuration. The second list of CSI-RS resource IDs may be associated with the second RIS configuration. The WTRU may determine a first set of CSI-RS resources based on the first list of CSI-RS resource IDs. The WTRU may receive the first CSI-RS using one or more CSI-RS resources of the first set of CSI-RS resources. The WTRU may determine a second set of CSI-RS resources based on the second list of CSI-RS resource IDs. The WTRU may receive the second CSI-RS using one or more CSI-RS resources of the second set of CSI-RS resources.

In examples, the WTRU may determine, based on the differential CSI measurement, a rank indicator (RI) associated with the BS-RIS-WTRU channel, a precoding matrix indicator (PMI) associated with the BS-RIS-WTRU channel, and/or a channel quality indicator (CQI) associated with the BS-RIS-WTRU channel. The WTRU may determine an RI associated with a BS-WTRU channel between the WTRU and a BS, a PMI associated with the BS-WTRU channel between the WTRU and the BS, and a CQI associated with the BS-WTRU channel between the WTRU and the BS. The WTRU may report the RI, PMI, and CQI associated with the BS-RIS-WTRU channel and the RI, PMI, and CQI associated with the BS-WTRU channel.

CSI acquisition is a function in wireless communication systems that may be used to adapt the transmission scheme, such as transmitter precoding. The CSI acquisition may be based on the WTRU-reporting of CSI that is based on measurement of reference signals, e.g., CSI-RS. With a reconfigurable intelligent surface (RIS) in the radio environment, a CSI procedure (e.g., the CSI acquisition procedure) may be extended to incorporate the adaptation of the RIS state in the presence of links (e.g., additional links) between WTRU-RIS and BS-RIS.

Features for RIS differential CSI acquisition are discussed in one or more examples herein. The features for differential channel estimation may be discussed and an associated procedure(s) may be developed in one or more examples herein. Enhancements associated with RIS CSI are discussed in one or more examples herein. CSI-RS transmission schemes (e.g., suitable CSI-RS transmission schemes for differential channel estimation) are discussed in one or more examples herein. CSI report change(s) (e.g., CSI report enhancements) may be proposed for RIS-aided differential channels. The RIS-aided differential channels may be changed (e.g., enhanced) to facilitate link adaptation and adaptation of the state of an RIS that has been deployed in a wireless communication system (e.g., while achieving enhanced communication performance).

Reconfigurable intelligent surface (RIS) may be included in a wireless network, for example, due to its capability of configuring a wireless propagation environment. An RIS may include a planar surface comprising a large number of sub-wavelength sized scattering elements to form unit-cells (e.g., also referred to as RIS elements herein), whose response may alter (e.g., dynamically alter) the electromagnetic properties (e.g., phase and/or amplitude) of an impinging signal with an electronic RIS controller. For example, by properly optimizing the state of RIS elements, an impinging signal may be directed towards a desired receiver while improving communication performance, e.g., higher spectral efficiency, enhanced coverage, etc. Along with providing an improved wireless communication environment, RIS elements may support one or more of the following applications: joint communication, sensing, and/or wireless power transfer. RIS elements may support one or more of the following features: reflection, refraction, focusing, collimation, polarization, etc. An RIS may be classified as passive, semi-active, or active. A passive RIS may shift the phase of an impinging signals and/or may include multiple passive elements. A semi-active and/or active RIS may offer phase shift and/or amplification gains. A semi-active RIS may include a number of active elements (e.g., a mixture of active and passive elements), while an active RIS may include active elements (e.g., all active elements or only active elements). Active RIS elements may provide sensing capabilities (e.g., may be referred to as autonomous RIS). The phase shifts or amplification gains may be applied at the RIS on an individual element level and/or on the group of RIS elements (e.g., a sub-surface level). The electromagnetic properties of individual or group of RIS elements may be altered (e.g., dynamically altered) with an RIS controller. The RIS controller may be co-located with the RIS or located remotely, for example, at the BS.

An RIS may be a type of network node. RIS aided communication may have three nodes (e.g., the BS, WTRU and RIS nodes). A communication path (e.g., a channel) may form via the RIS, e.g., BS-RIS-WTRU path referred as the RIS-aided path along with the legacy BS-WTRU direct communication path. In an RIS-aided communication, there may be multiple paths between the BS and the WTRU, e.g., a path via the RIS (RIS-aided path) and one or more paths contributing the BS-WTRU direct path.

The overall channel (e.g., it may be referred to as a cascaded RIS channel estimation in some instances) between the BS and WTRU may be estimated (e.g., including estimating the RIS-aided BS-RIS-WTRU composite channel and the direct path's BS-WTRU channel). Estimating the RIS-aided BS-RIS-WTRU path may be referred to as differential channel estimation. With the presence of different communication channel paths in RIS-aided communication, different communication aspects (e.g., problems) including initial access, beamforming, control signaling, channel acquisition and CSI reports etc., may be updated to enable the RIS-aided communication path and support the introduction of an RIS in the network. Features across channel acquisition and CSI reporting to enable differential channel estimation in the RIS-aided communication scenario may be disclosed in one or more examples herein.

The term RIS may denote the RIS itself, the RIS and RIS controller, or the RIS controller (e.g., the RIS controller may be separate from the BS, collocated with the BS, or part of the BS). A BS may communicate with the RIS (e.g., it may be assumed that the BS can communicate with the RIS). The BS may communicate with the RIS (e.g., using the NR air interface, to provide RIS with control information). The terms RIS unit-cells and RIS elements may be used interchangeably in one or more examples herein.

An example RIS system may include one or more RIS elements. An example RIS system may include multiple RIS elements of an RIS (e.g., of a single RIS). An example RIS system may include an (e.g., one) RIS element of an RIS (e.g., of a single RIS). Various RIS systems may be described herein with respect to a downlink (DL) implementation, but the same or similar systems (e.g., the same or a similar models) may be applicable to an uplink (UL) implementation.

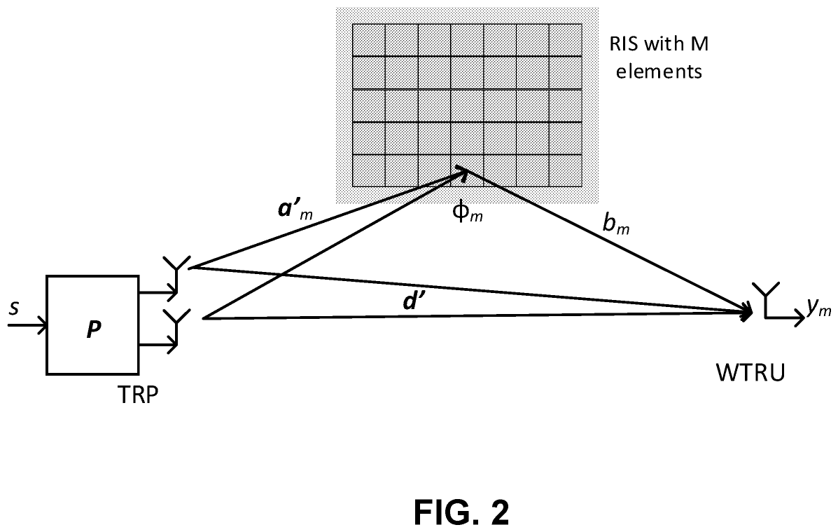

For simplicity, a single-antenna WTRU and a narrowband system (e.g., a subcarrier of an OFDM system) may be used in the examples provided herein (e.g., including the example system in FIG. 2). Such system (e.g., such model) may apply to cases with a multi-antenna WTRU such as a WTRU that may combine multiple received signals into a single received signal based on receiver processing (e.g., using analog, digital, or hybrid beamforming or combining techniques). In one or more of these examples, such receiver processing may be included in a radio channel.

An RIS system (e.g., an RIS system model) may include one RIS element of an RIS (e.g., one of M RIS elements of the RIS), as illustrated in FIG. 2. The example RIS system (e.g., an RIS system model) in FIG. 2 may include an RIS element, TRP(s) and WTRU(s). In at least this scenario, an example of a signal (e.g., an equivalent baseband received complex-valued scalar signal) yₘ at a WTRU may be given by Equation 1.

$${y}_{m} = ( {b}_{m} {a}_{m}^{′} {ϕ}_{m} + {d}^{′} ) Ps + z \qquad ( 1 )$$

wherein s may represent a complex-valued scalar symbol such as a reference/pilot symbol (e.g., a known reference/pilot symbol), P may represent a complex-valued precoding vector of dimension N_{T}×1 (e.g., N_{T} may be the number of transmit antennas, for example, at a network-side transmission reception point (TRP)), d′ may represent a complex-valued channel between the TRP and the WTRU (e.g., excluding propagation paths via an RIS of dimension 1×N_{T}), a′ₘ may represent a complex-valued vector channel between the TRP and the RIS element of dimension 1×N_{T}, φₘ may represent a complex-valued scalar RIS element factor of RIS element m, with m=1, . . . , M, bₘ may represent a complex-valued scalar channel between the RIS element and the WTRU, and z may represent additive noise and/or interference.

In a passive RIS, factor φₘ may have a fixed amplitude, e.g., a unit amplitude (|φₘ|=1). In an active or hybrid RIS, the amplitude may be variable and/or controllable. In some cases, e.g., for a passive RIS, an RIS element may be turned off (e.g., φₘ=0 or φₘ≈0). An RIS element may be in a certain state (φₘ) at a time and may be assumed to be applicable to one or more (e.g., all) sub-carriers within a certain bandwidth.

The terms reference signal (RS) and pilot may be used interchangeably herein. In OFDM, an RS/pilot may include multiple (e.g., known) reference/pilot symbols. The reference/pilot symbols may be mapped to different sub-carriers and/or OFDM symbols.

The example shown in FIG. 2 may be simplified, for example, by including TRP precoding P into the TRP-to-RIS channel. Equation 2 below may be applicable in such a scenario:

$${y}_{m} = ( {b}_{m} {a}_{m} {ϕ}_{m} + d ) s + z = ( {c}_{m} {ϕ}_{m} + d ) s + z \qquad ( 2 )$$

wherein d=d′P may represent a complex valued scalar effective direct TRP-to-RIS channel (e.g., including TRP precoding),

$${a}_{m} = {a}_{m}^{′} P$$

may represent a complex-valued scalar channel between the TRP and the RIS element, cₘ=bₘaₘ may represent a cascaded complex-valued scalar channel from the TRP to an m:th RIS element to the WTRU.

An RIS system (e.g., an RIS system model) may include multiple RIS elements of an RIS (e.g., all M RIS elements of the RIS). Such a system may be established, for example, by including signals corresponding to the RIS elements (e.g., M RIS elements) of the RIS (cₘφₘs) in the system, e.g., according to Equation 3 below:

$$y = ( ( a ⊙ b ) Φ + d ) s + z = ( c Φ + d ) s + z \qquad ( 3 )$$

wherein a may represent a complex-valued vector channel between the TRP and the RIS, of dimension 1×M (e.g., M may be the number of RIS elements), b may represent a complex-valued vector channel between an RIS element and the WTRU (e.g., of dimension 1×M), c=a⊙b may represent an element-wise (e.g., Hadamard) product of a and b, and ω may represent a complex-valued vector of dimension M×1 containing the M RIS element factors φₘ. Φ may correspond to an RIS state.

In examples (e.g., with rectangular RIS), Mₓ may denote the number of RIS elements in a first direction (e.g., horizontal), M_{y} may denote the number of RIS elements in a second direction (e.g., vertical), and M may be equal to Mₓ*M_{y}.

RIS element channels may be estimated. For example, to estimate the cascaded channel c and/or the direct channel d in Equation 3, a network device may transmit a number of pilot/reference symbols (e.g., a number of known pilot/reference symbols) s. Since the cascaded channel c may include M elements (e.g., a pilot symbol may be associated with an element of the cascaded channel c) and direct channel d may include one element (e.g., a pilot symbol may be associated with the element of the direct channel d), M+1 pilot/reference symbols may be used to estimate the channel (e.g., to estimate the channel coefficients).

For simplicity of notation, the same pilot symbol s may be assumed herein in M+1 occasions, but the pilot symbols may be different in different occasions (e.g., according to a certain complex-value sequence, as long as it is known by a WTRU). For example, a first pilot symbol may be used for the first occasion, and the second pilot symbol may be used for a second occasion. The first pilot symbol and the second pilot symbol may be different. Some (e.g., all) received pilot symbols may be combined, e.g., in accordance with Equation 4 below:

$$y = h Θ s + z \qquad ( 4 )$$

wherein y=[y₀ . . . y_{M}] may represent the M+1 received pilot symbols and h=[d c] may represent a 1×(M+1) vector with a direct channel and M channels via the RIS. Θ may be equal to

$$[ \begin{matrix}1 & … & 1 \\ {Φ}_{0} & … & {Φ}_{M}\end{matrix} ] ,$$

where Φᵢ may be an M×1 vector with RIS element factors during the i:th pilot symbol, and Θ may be a square matrix with a dimension of M×1. Θ may be called an RIS estimation matrix. z=[z₀ . . . z_{M}] may represent noise (e.g., received noise) and/or an interference (e.g., a received interference).

In examples (e.g., with Θ having a full rank known to the WTRU), the channels may be estimated based on y, e.g., in accordance with Equation 5 below. The channels may be estimated using an approach (e.g., one based on minimum mean square errors (MMSE).

$$\hat{h} = \frac{1}{s} y {Θ}^{- 1} \qquad ( 5 )$$

Φᵢ may be designed using different approaches. For example, in the on-off method described herein, RIS elements (e.g., all RIS elements) may be turned off (e.g., Φ₀=0 or Φ₀≈0) during a pilot symbol (transmission) such as a first pilot symbol (transmission). This may result in a received pilot symbol such as in Equation 7.

The direct channel d may be estimated, for example, by the WTRU. For example, during pilot symbols 1 to M (transmissions), RIS elements may be turned on one-by-one (e.g., with other elements still turned off). For example, the ith RIS element may be turned on during the ith pilot symbol (transmission). This may result in a received i:th pilot symbol, for example, as in Equation 6.

$${y}_{i} = ( {c}_{i} {ϕ}_{i} + d ) s + {z}_{i} with i = 1 , … , M \qquad ( 6 )$$

Φᵢ may be zero (e.g., all zero), except that the i:th element Φᵢ may be equal to 1. For example, Φᵢ may be equal to

$$[ \begin{matrix}1 \\ {I}_{M}\end{matrix} ]$$

wherein 1 is an all-ones M-dimensional row vector and I_{M} is the identity matrix of dimension M. This example may assume that the RIS elements may be turned on in the order of RIS element indices, but those skilled in the art will understand that the RIS elements may be turned on in other orders.

In examples, Φᵢ may be vectors without elements equal to zero (e.g., multiple (e.g., all) RIS elements may be turned on during pilot symbol transmissions). In examples, Θ may be a discrete fourier transform (DFT) matrix. In examples, Θ may be a Hadamard matrix. In at least these examples, Θ⁻¹ may be equal to OT which may simplify implementation.

An RIS-reflected aggregate channel may be estimated (e.g., cascaded channel estimation). The channel in Equation 3 includes the direct channel d and the RIS-reflected aggregate channel cΦ: (cΦ+d). In one or more examples herein, the term “channel”, “path”, and “channel path” may be used interchangeably. The aggregate channel cΦ may be scalar since it includes the aggregate (sum) of the RIS element reflections. The two components d and cΦ may be estimated based on two pilot symbols. During a first pilot symbol (transmission), the RIS may be turned off, with a received pilot symbol, for example, as in Equation 7.

$${y}_{0} = ds + {z}_{0} \qquad ( 7 )$$

The WTRU may estimate the direct channel d (e.g., using a state-of-the-art channel estimation method).

During a second pilot symbol (transmission), the RIS may be turned on, with a certain RIS state Φ, e.g., as in Equation 8.

$${y}_{1} = ( c Φ + d ) s + {z}_{1} = h s + {z}_{1} \qquad ( 8 )$$

The WTRU may estimate h (e.g., using a state-of-the-art channel estimation method). The WTRU may estimate the RIS-reflected aggregate channel cΦ based on the two pilot symbols.

In examples, the number of RIS elements on an RIS may be high. Channel estimation and/or CSI reporting per RIS element may be costly, e.g., in terms of overheads and signaling. The cost for channel estimation and/or CSI reporting may be reduced, for example, by using a differential channel estimation as described in one or more examples herein. For example, the differential channel estimation as described in one or more examples herein may be performed (e.g., as opposed to performing channel estimation per sub-surface/RIS element and/or processing (e.g., aggregating) the channel estimation per sub-surface/RIS element).

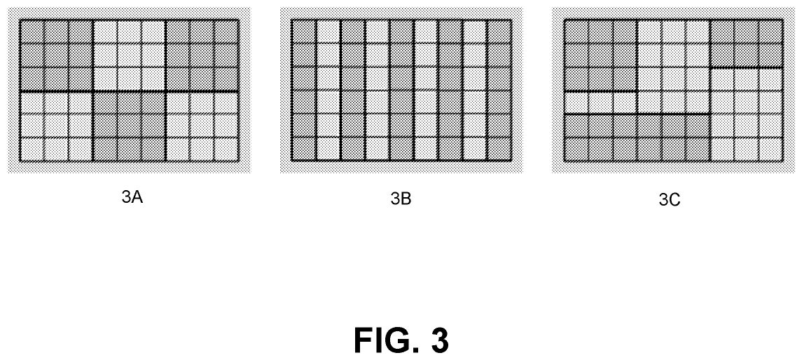

The cost for channel estimation and/or CSI reporting may be reduced, for example, by introducing sub-surface-based estimation and reporting. The RIS elements of an RIS may be distributed (e.g., grouped) into S sub-surfaces including, e.g., Sₓ horizontal elements and S_{y} vertical elements in a sub-surface. The distribution of the RIS elements into the sub-surfaces may be uniform (e.g., the same number of RIS elements per sub-surface) or non-uniform (e.g., different numbers of RIS elements for different sub-surfaces). In the case of multi-panel RIS, a (e.g., each) panel may be considered a sub-surface, or a (e.g., each) panel may be divided into multiple sub-surfaces. A multi-panel RIS may include several panels, and a panel (e.g., each panel) may contain a group of unit-cells or scattering elements (e.g., the group of unit-cells or scattering elements may be collectively controlled within each panel to direct and manipulate electromagnetic waves). FIGS. 3A-3C illustrate examples of RIS element distribution into sub-surfaces. FIG. 3A and FIG. 3B illustrate examples of uniform distribution while FIG. 3C illustrates an example of non-uniform distribution. In case where different RIS surfaces may be allocated to different users, the number of RIS elements or resources allocated to a user (e.g., a WTRU) may be increased or decreased (e.g., non-uniform RIS distribution may be used). A WTRU requesting more resources may be allocated a sub-surface with a bigger dimension (e.g., having more RIS elements) whereas a sub-surface with a smaller dimension (e.g., having fewer RIS elements) may be reserved for a WTRU with a less-stringent request and/or requirement.

The number of pilots for CSI and/or channel acquisition may be M+1 (e.g., in the case of element-wise RIS aggregated channel estimation). In some examples, with increased RIS surface size, the computational complexity of the estimation process may increase tremendously, making the process of channel estimation inefficient and/or time-consuming. One or more examples herein (e.g., the differential channel estimation and/or the division of the RIS into sub-surfaces) may reduce the computational complexity of the estimation process even when the size of an RIS increases.

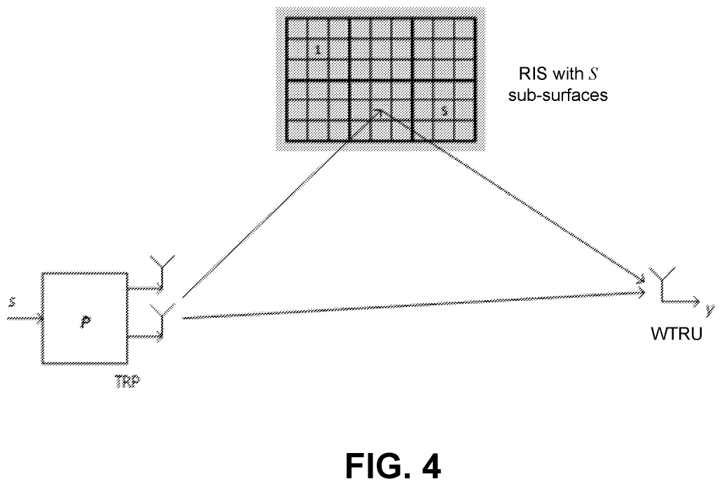

In examples, channel estimation may be performed by dividing and/or grouping RIS elements into smaller groups (e.g., which may be referred to herein as sub-surfaces) and performing the channel estimation at a sub-surface level. Such a sub-surface may include a set of one or more RIS elements. The distribution of RIS elements into sub-surfaces may be uniform or non-uniform. In the case of multi-panel RIS, a (e.g., each) panel may be considered a sub-surface, or a (e.g., each) panel may be further divided into multiple sub-surfaces. FIG. 4 Illustrates an example of an RIS-aided system where an RIS is partitioned into S (e.g., S=6) sub-surfaces.

An RIS state may be configured at a sub-surface level (e.g., the same RIS element factor φₘ may be applied to the (e.g., all) RIS elements in a sub-surface). Sub-surface level channel estimation may be performed by sending a (e.g., one) pilot per sub-surface (e.g., rather than a pilot per RIS element). By introducing the sub-surfaces, the dimension of the channel estimation may be reduced from M+1 to S+1 (e.g., in terms of pilot transmissions and/or computation). The on-off method and/or the on method described in one or more examples herein may be applied to sub-surfaces (e.g., instead of to individual RIS elements), for example, to reduce pilot overheads and/or channel estimation complexity.

The RIS system (e.g., the RIS model) described in one or more examples herein (e.g., the example shown in FIG. 2) may be used to illustrate RIS operation(s) based on sub-surfaces (e.g., the RIS operation(s) of FIG. 4). Let Γⱼ denote a set of RIS element indices in the j:th sub-surface, with j=1, . . . , S. The union of sub-surfaces may include multiple (e.g., all) RIS element indices, e.g., UⱼΓⱼ={1, . . . , M}, and, in some examples, the sub-surface sets may be disjoint. Let γⱼ be an M×1 vector with ones on the rows given by the indices in Γⱼ, and zeroes elsewhere (e.g., the row indexing may start at 1 for simplicity). The RIS elements in γⱼ may be selected corresponding to the j:th sub-surface.

Let G=[γ₁ . . . γₛ] be a sub-surface selection matrix of dimension M×S. Equation 3 (e.g., which may represent a system model) may be written as Equation 9 below:

$$y = ( c G {Φ}^{s} + d ) s + z = ( {c}^{s} {Φ}^{s} + d ) s + z \qquad ( 9 )$$

wherein Φ^{s} may represent a complex-valued vector of dimension S×1 including the S sub-surface factors

$${ϕ}_{j}^{s} ,$$

where factor

$${ϕ}_{j}^{s}$$

may be applied to the RIS elements in Γⱼ, e.g.,

$${ϕ}_{m} = {ϕ}_{j}^{s} ∀ m ∈ {Γ}_{j} ,$$

and the same RIS element factor φⱼ^{s} may be applied to an (e.g., each) element in the j:th sub-surface. c^{s}=cG may represent a 1×S dimensional vector including S per sub-surface RIS-reflected aggregate channels (e.g., the j:th element of c^{s} may equal Σrⱼcₘ.)

(c^{s}Φ^{s}+d) in Equation 9 may have the same form as (cΦ+d) in Equation 3, except for the length of the vectors, which may be S in the former (e.g., representing the number of sub-surfaces) and M in the latter (e.g., representing the number of RIS elements). A method for channel estimation, CSI, etc. that may be applicable to per RIS element operation may be applicable to per sub-surface operation, and vice versa.

For example, the description in one or more examples herein on RIS channel estimation may be applicable by changing the problem dimension by adding the s superscript. h=[d c^{s}] may be a 1×(S+1) vector with the direct channel and the S channels via the RIS sub-surfaces.

$$Θ = [ \begin{matrix}1 & 1 & … & 1 \\ {Φ}_{0} & {Φ}_{1}^{s} & … & {Φ}_{S}^{s}\end{matrix} ] ,$$

where

$${Φ}_{i}^{s}$$

may be the S×1 vector with the RIS sub-surface factors during the i:th pilot symbol. Θ may be a square matrix with dimension (S+1)×(S+1).

In downlink transmission(s) (e.g., downlink transmission(s) associated with NR), the BS/TRP may transmit the CSI-RS that is used for channel sounding. The WTRU may (e.g., with the CSI-RS) perform the measurements to estimate the quality of the channel based on the received reports (e.g., either implicitly and/or explicitly) by the WTRU.

A first mode of DL CSI acquisition (e.g., associated with NR) may be based on a WTRU performing measurements on one or more CSI-RS and reporting corresponding CSI. A second mode of DL CSI acquisition (e.g., associated with NR) may be based on a WTRU transmitting a sounding reference signal (SRS), e.g., including one or more of: antenna switching between antennas that may be used for DL reception, CSI measurement at the network side, and/or the assumption of UL/DL reciprocity (e.g., CSI estimated on the UL may be applicable to the DL).

A WTRU may be configured to perform channel measurement and/or compute CSI using a CSI-RS resource, which may include one or multiple ports (e.g., antenna ports). One or multiple CSI-RS resources may be grouped into a CSI-RS resource set. A WTRU may be configured to perform interference and/or noise measurement on a CSI-RS resource for CSI. In examples, a CSI-RS resource may be a non-zero power (NZP) CSI-RS resource, in which a WTRU may assume a certain RS being transmitted. In some examples, a CSI-RS resource may be a CSI-RS resource for interference measurement, in which a WTRU may not assume a certain RS being transmitted. CSI-RS resources and resource sets may be, for example, non-zero power (NZP) CSI-RS resources and resource sets or interference measurement (IM) CSI-RS resources or resource sets. For brevity, the terms CSI-RS resource(s) and CSI-RS resource set(s) are used herein, which may refer to either NZP and/or IM CSI-RS resource(s) and resource set(s).

A CSI-RS resource may be periodic, semi-persistent (e.g., which may be activated/deactivated), or aperiodic (e.g., which may be triggered). A WTRU may be configured with periodic, semi-persistent, or aperiodic CSI reporting. In examples, periodic CSI reports may be transmitted on the physical uplink control channel (PUCCH), while aperiodic CSI reports may be transmitted on the physical uplink shared channel (PUSCH). Semi-persistent CSI reports may be configured to be transmitted on the PUCCH or on a semi-persistent PUSCH.

A CSI report may be based on channel measurements on a resource set, e.g., a CSI-RS resource set. A (e.g., each) channel measurement resource may be associated with an interference measurement resource and/or a non-zero power CSI-RS resource for interference measurement.

A WTRU may report CSI corresponding to one or more resources in a resource set for channel measurement. If the resource set includes multiple resources, the WTRU may report a resource index, for example, to identify the corresponding resource used. Such a resource index may include a CSI-RS resource indicator (CRI) or an SSB resource indicator (SSBRI).

In examples (e.g., if a multi-port CSI-RS is used as a channel measurement resource), a WTRU may be configured to compute one or more precoding matrix indicators (PMI), e.g., a wideband PMI and/or a number of sub-band PMIs. A PMI may, for instance, correspond to a precoding vector or matrix selected directly from a codebook. A PMI may include a combination (e.g., linear combination) of multiple precoding vectors or matrices from a codebook.

A CSI report may include one or more channel quality indicators (CQI). If the CSI report includes a PMI, the CQI may correspond to a set of layers of the PMI. A CSI report may include a wideband CQI (e.g., if wideband physical downlink shared channel (PDSCH) transmission is performed). A CSI report may include sub-band CQI (e.g., if sub-band PDSCH transmission is performed).

A WTRU may receive one or multiple CSI-RS resources (e.g., in a CSI-RS resource set) and may acquire the downlink CSI using the received CSI-RS resource set. The WTRU may perform measurements and report the acquired CSI based on the performed measurements (e.g., through PUCCH or PUSCH).

An RIS may be represented by one or more RIS parameters (e.g., phase shift(s) and amplification gain(s) associated with an RIS state that is configured using an RIS configuration. If an RIS is present in a communication system, the RIS may introduce phase shift(s) and amplification gain(s) to an impinging signal based on a predefined/set RIS state, e.g., as configured by a controlling node (e.g., RIS controller, BS, WTRU, etc.), and reflect the impinging signal, for example in a direction (e.g., an intended direction). An RIS may be composed of RIS unit-cells (e.g., a large number of RIS unit-cells), which may be capable of (e.g., individually or jointly as a set of RIS elements) introducing the amplification gain(s) and/or phase-shift(s). During the communication between a BS and a WTRU, multiple channel components may be used (e.g., a direct path between the BS and the WTRU and/or an RIS aided BS-RIS-WTRU path). To improve the communication quality, both these paths (e.g., BS-WTRU and/or BS-RIS-WTRU) may be optimized (e.g., separately or jointly), e.g., by utilizing CSI reports. In some examples, some reports (e.g., legacy reports) measured effectively over the paths (e.g., all the paths) may not be efficient to optimize the RIS-aided BS-RIS-WTRU path, and/or utilizing the reporting feedback for these reports, it may be difficult to infer the effect of the RIS-aided BS-RIS-WTRU path.

RIS-aided path channel estimation (e.g., differential channel) may be described in one or more examples herein, where the channel estimation may be performed by the BS and/or WTRU. The differential channel may be utilized to optimize the BS-RIS-WTRU path through incorporating one or more of RIS-aided link adaptation (e.g., to update system parameters, such as precoder, modulation, etc.), RIS parameter adaptation (e.g., to update RIS state etc.), etc. To achieve these communication gains through differential channel estimation, changes to some CSI-RS transmission and CSI reports (e.g., enhancements to the legacy CSI-RS transmission and CSI reports in the NR) may be made to incorporate the RIS-aided BS-RIS-WTRU path. CSI-RS changes (e.g., CSI-RS enhancements in NR) may enable the differential channel estimation. Changes in CSI reports/feedback (e.g., enhancements in the NR CSI reports/feedback) may incorporate the effect of the differential channel in the communication system.

The CSI estimation and reporting by the WTRU to the BS may be used by the BS for link adaptation, such as adjusting the BS transmission scheme, for example, in terms of one or more of: modulation and coding, multi-antenna precoding, or frequency domain resource allocation. Adjustments may pertain to improving the received signal quality, for example, precoding and frequency-selective scheduling. Adjustments may pertain to achieving a certain block error rate (e.g., modulation and coding scheme (MCS) selection). The estimated CSI and reporting may be utilized to update or adjust an RIS state. In examples, the adjustment of the RIS state may be similar to precoder selection and/or to MCS selection (e.g., more similar to precoder selection than MCS selection). The adjustment of the RIS state may improve the received signal quality. Some CSI procedures may not support CSI-based adjustments for RIS-aided communication. In one or more examples as described herein, the effect of an RIS-aided differential channel in the communication system may be incorporated through changes to CSI-reports (e.g., through enhancements in the NR CSI-reports).

Differential CSI acquisition based on CSI-RS may be changed (e.g., enhanced) to facilitate link adaptation and/or adaptation of the state of an RIS that has been deployed in a wireless communication system. One or more of the WTRU, the RIS, and the BS may be changed (e.g., enhanced). The communication link performance may be improved based on the acquired differential channel estimates. A WTRU may be configured with CSI-RS and/or RIS CSI (e.g., CSI-RS enhancements and/or RIS CSI enhancements).

A WTRU may measure CSI-RS(s) and/or compute an RIS differential channel. A WTRU may compute CSI reports (e.g., enhanced CSI reports) using acquired differential RIS channels and may send the CSI reports (e.g., to report the CSI). Based on the CSI reports (e.g., as feedback from the WTRU), a BS may configure/update a precoder and/or RIS state(s) and indicate the RIS state(s) to the RIS.

Features associated with differential channel estimation may be described in one or more examples herein. In an RIS-aided communication (e.g., using direct (BS-WTRU) channel component and multi-path fading components), the WTRU may receive data, in case of downlink communication(s), along one or more paths (e.g., mainly along two-paths) that include the RIS-aided path (BS-RIS-WTRU path) and the direct path (BS-WTRU path). The differential channel may correspond to (e.g., may be) the effective RIS-aided channel path gain (c) at the WTRU in case of downlink transmission(s). Information on a differential channel (e.g., gained through differential channel estimation) may benefit in evaluating the effect and performance of an RIS in a communication. The information may be utilized in generating reports (e.g., enhanced reports) and link adaptation for the RIS-aided path. Obtaining differential channel coefficients may result in improved communication performance.

The RIS-aided channel may be used in one or more examples herein (e.g., may be referred to as an RIS cascaded channel or an RIS-reflected aggregate channel in some instances). The terms differential channel, cascaded channel, and aggregate channel may be interchangeably used in one or more examples as described herein, and they may refer to the RIS-aided channel path (e.g., the BS-RIS-WTRU channel).

Features associated with differential channel estimation may be described in one or more examples herein. In one or more examples herein that describe differential channel estimation, it may be considered that an RIS is turned on during pilot transmissions (e.g., during all the pilot transmissions). The RIS state may be set (e.g., as per the set radio resource control (RRC) configuration as described in one or more examples herein) element-wise, sub-surface wise, or a state for an RIS (e.g., a single state for a complete RIS). For example, a state of an RIS (e.g., a single state of an RIS) may be set in an orthogonal space which may be configured to belong to the codewords from (e.g., different) orthogonal dictionaries (e.g., Hadamard matrix, DFT etc.) during a set of pilot transmissions. The WTRU may be configured by the BS, and the BS may indicate the selected orthogonal dictionary for the RIS state and/or enable differential channel estimation at the WTRU end.

If the RIS state is set to Φ₁ and a pilot (e.g., a known pilot) s is transmitted by the transmitter (e.g., a BS in a case of downlink transmission(s), the received signal at the WTRU may be given by Equation 10.

$${y}_{1} = ( c {Φ}_{1} + d ) s + {z}_{1} \qquad ( 10 )$$

If the RIS state is set to Φ₂, the received signal at the WTRU may be given by Equation 11.

$${y}_{2} = ( c {Φ}_{2} + d ) s + {z}_{2} \qquad ( 11 )$$

The differential channel may be obtained by subtracting Equation 10 and Equation 11 as follows,

$${y}_{2} - {y}_{1} = c ( {Φ}_{2} - {Φ}_{1} ) s + ( d - d ) s - ( {z}_{2} - {z}_{1} )$$

$$c ( {Φ}_{2} - {Φ}_{1} ) = \frac{1}{s} ( {y}_{2} - {y}_{1} ) + z$$

$$c {‖ ( {Φ}_{2} - {Φ}_{1} ) ‖}^{2} = \frac{1}{s} ( {y}_{2} - {y}_{1} ) {( {Φ}_{2} - {Φ}_{1} )}^{H} + z {( {Φ}_{2} - {Φ}_{1} )}^{H}$$

The estimated RIS-aided channel may be given in Equation 12:

$$\tilde{c} = \frac{1}{s {‖ ( {Φ}_{2} - {Φ}_{1} ) ‖}^{2}} ( {y}_{2} - {y}_{1} ) {( {Φ}_{2} - {Φ}_{1} )}^{H} \qquad ( 12 )$$

The obtained differential channel gains c may correspond to (e.g., may be) the resultant RIS-aided channel path that may be utilized for RIS specific performance analysis and/or reporting.

In a case of sub-surface based channel estimation (e.g., as described in one or more examples herein), where the complete RIS is distributed into M sub-surfaces, the differential channel for m-th sub-surface may be obtained in Equation 13:

$${\tilde{c}}_{m} = \frac{1}{s} ( {y}_{2 , m} - {y}_{1 , m} ) {( {Φ}_{2 , m} - {Φ}_{1 , m} )}^{- 1} \qquad ( 13 )$$

wherein, y_{i,m} may represent the received signal at the WTRU, and the RIS state for m-th sub-surface may be set to Φ_{i,m} for i-th pilot transmission. One sub-surface may be turned-on at a given time, and/or the sub-surface state may be mutually orthogonal to each other. The effective additive noise and interference component (Z₂-Z₁) may be compensated by using additive noise and interference cancellation.

The direct channel path may be calculated (e.g., calculated implicitly as the effect of the direct channel path may not be explicitly captured in some of the examples herein) by the WTRU utilizing the differential channel knowledge and the received signal. In some examples (e.g., a special case of the differential channel estimation as described in one or more examples herein), the direct channel path may exploited to obtain the differential channel c. In such a case, in one of the pilot transmissions (e.g., i=1), RIS may be turned off (Φ₁=0), resulting in the received signal in Equation 14:

$${y}_{1} = d s + {z}_{1} \qquad ( 14 )$$

In one of the pilot transmissions (e.g., i=2), the RIS state may be set to Φ₂, and the received signal may be given in Equation 15:

$${y}_{2} = ( c {Φ}_{2} + d ) s + {z}_{2} \qquad ( 15 )$$

The differential channel may be obtained as follows:

$${y}_{2} - {y}_{1} = ( c {Φ}_{2} + d ) s - d s + {z}_{2} - {z}_{1}$$

$${y}_{2} - {y}_{1} = ( c {Φ}_{2} + d ) s - d s + z$$

$$\tilde{c} = \frac{1}{s} ( {y}_{2} - {y}_{1} ) {Φ}_{2}^{- 1}$$

In some examples, if a WTRU is unaware of the presence of an RIS, a WTRU may measure the CSI for states 1 and 2 and report the CSI (e.g., as a legacy CSI reports to the BS). Utilizing the received reports (e.g., the CSI reports from the WTRU for the two RIS states), the BS may compute the differential CSI. The BS may compute the channel quality indicators, for example, to perform the link adaptation and/or update the RIS state.

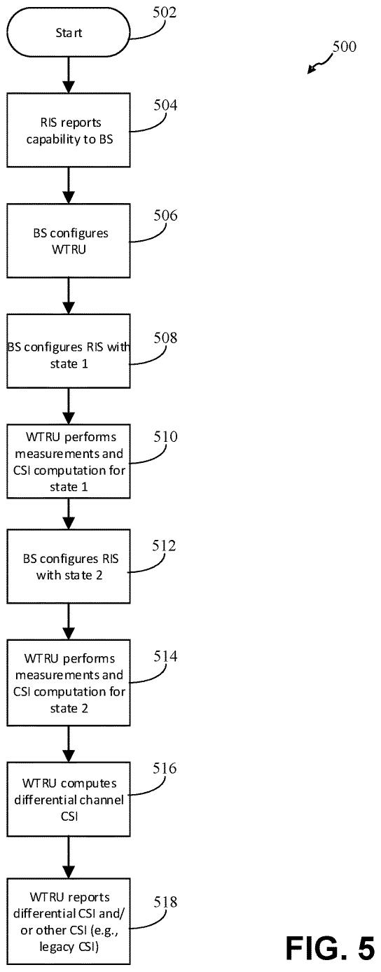

FIG. 5 illustrates example 500 (e.g., a differential channel estimation example), where one or more of the described actions may be performed. For example, a WTRU may perform one or more of 510, 514, 516, or 518.

An example implementation (e.g., using FIG. 5) may include nodes for RIS differential channel estimation using the differential channel estimation as described in one or more examples herein. Network nodes, such as one or more base stations (e.g., gNBs), one or more TRPs, one or more RISs, etc., and/or one or more WTRUs, etc., may be included in an example system (e.g., a system that is used to perform one or more of 502-518).

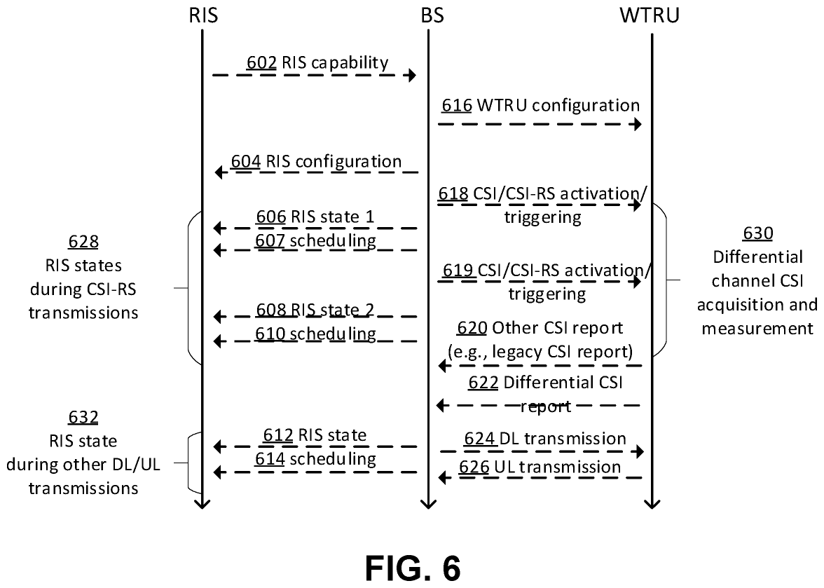

As shown in FIG. 5, at 502, the example of 500 may start. At 504, a node (e.g., an RIS node) may (e.g., also shown at 602 of FIG. 6) indicate its capabilities (e.g., the node may report its capabilities including one or more of: a number of RIS elements, a structure of the RIS (e.g., rectangular, circular, etc.), a sub-surface or elementwise configuration capability, a resolution of the RIS, etc.). In examples, the node may indicate its capabilities to a BS. The WTRU may be configured at 506 (e.g., also shown at 616 at FIG. 6). In examples, the BS may, based on the capability information indicated by the node (e.g., utilizing this RIS capability knowledge), configure the WTRU at 506, for example, in a manner related to RIS CSI enhancements (e.g., including one or more of legacy and/or RIS aided CSI reporting configurations, RIS state configurations, sub-surface or elementwise RIS operation configuration, etc.). For example, the BS may send configuration information to the WTRU to configure the WTRU.

At 508, the BS may (e.g., also shown at one or more of 604-607 of FIG. 6) configure the RIS with the required configuration and/or set the RIS state 1 (e.g., by sending the RIS controller of the RIS configuration information: for example, a first RIS configuration may correspond to RIS state 1; a second RIS configuration may correspond to RIS state 2). At 510, a WTRU may (e.g., also shown at 618 of FIG. 6) perform the CSI acquisition with respect to the set RIS state 1. For example, the WTRU may receive a first CSI-RS associated with a first set of RIS parameters that represent RIS state 1. The WTRU may determine a first channel measurement based on the first CSI-RS and/or the first set of RIS parameters.

508 and 510 may be repeated at 512 and 514 respectively with RIS state 2 (e.g., a different RIS state), as set by the BS. At 512, the BS may (e.g., also shown at one or more of 604, and 608-610) of FIG. 6) configure the RIS with the required configuration and/or set the RIS state 2 (e.g., by sending the RIS controller of the RIS configuration information). At 514, a WTRU may (e.g., also shown at 619) perform the CSI acquisition with respect to the set RIS state 2. For example, the WTRU may receive a second CSI-RS associated with a second set of RIS parameters that represent RIS state 2. The WTRU may determine a second channel measurement based on the second CSI-RS and/or the second set of RIS parameters.

RIS states 1 and 2 may be selected from a pre-defined dictionary, and/or they may be the required RIS states at two different time slots.

At 516, the WTRU may perform the differential channel estimation (e.g., as shown at 630 of FIG. 6), for example, by utilizing the acquired CSI in at 510 and 514. The WTRU may perform the differential channel estimation, for example, by determining a difference between the measurement and CSI computation for state 1 and the measurement and CSI computation for state 2. The WTRU may perform the differential channel estimation, for example, using Equation 12. In examples, the differential channel estimation may be determined by subtracting the measurement and CSI computation for state 2 from the measurement and CSI computation for state 1.

At 518, the WTRU may (e.g., also shown at 620 and 622 of FIG. 6) report the differential CSI measurements and/or legacy reports, for example, to the BS. For example, the WTRU may determine, based on the differential CSI measurement, one or more of a rank indicator (RI), a precoding matrix indicator (PMI), a channel quality indicator (CQI) associated with the BS-RIS-WTRU channel, as described in one or more examples herein. The WTRU may determine an RI, a PMI, and a CQI associated with a BS-WTRU channel between the WTRU and a base station. The WTRU may report the RI, PMI, and CQI associated with the BS-RIS-WTRU channel and the RI, PMI, and CQI associated with the BS-WTRU channel.

FIG. 6 illustrates an example signaling diagram for differential channel estimation (e.g., RIS differential channel estimation). Additional signaling may be used in scenarios, for example, when sub-surface based or element-wise RIS configuration is used or if the WTRU reporting is varied based on NR specifications, such as periodic, semi-persistent, aperiodic, etc. Signaling in one or more of 602-614 and/or one or more of 616-626 in FIG. 6 may be omitted in examples. As shown in FIG. 6, RIS capability information may be sent from an RIS to a BS at 602. At 604, the BS may send RIS configuration information to the RIS (e.g., the RIS controller). At 606, the BS may set the RIS RIS state 1. At 607, the BS may send scheduling information (e.g., scheduling information associated with RIS state 1) to the RIS. At 608, the BS may set the RIS RIS state 2. At 610, the BS may send scheduling information (e.g., scheduling information associated with RIS state 2) to the RIS. 628 may include RIS states during CSI-RS transmissions. 628 may include one or more of 606-610. At 612, the BS may set the RIS an RIS state (e.g., the RIS state that is the same or different from RIS state 1 or RIS state 2). At 614, the BS may send the RIS scheduling information (e.g., the scheduling information associated the RIS state that is set at 612). 632 may include an RIS state during other DL/UL transmissions. 632 may include 612-614.

As shown in FIG. 6, the BS may send a WTRU WTRU configuration information at 616. At 618, the BS may send first CSI/CSI-RS activation/triggering to the WTRU. At 619, the BS may send second CSI/CSI-RS activation/triggering to the WTRU. The WTRU may send differential CSI report at 622 and/or other CSI report (e.g., legacy CSI report) at 620. 630 may be used for the differential channel CSI acquisition and measurement as described in one or more examples herein. 630 may include 606-610 and 618-619. The WTRU may receive DL transmission(s) at 624. The WTRU may send UL transmission(s) at 626.

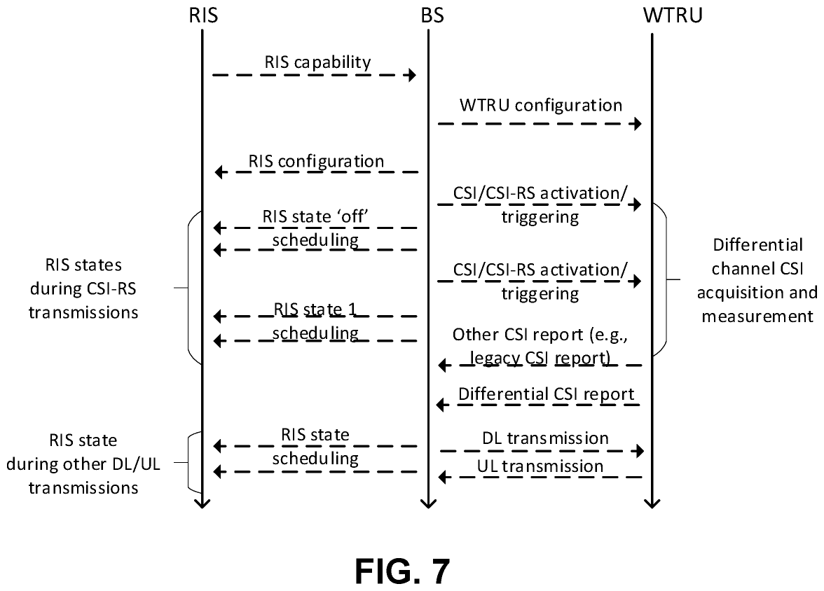

The signaling diagram for a case of the example approach (e.g., a special case for the example shown in FIG. 5 and/or the example shown in FIG. 6) may be illustrated in FIG. 7, wherein the RIS state is set as off in one of the pilot transmissions following the RIS state being set to Φ₁ in another pilot transmission. FIG. 7 illustrates an example signaling diagram for differential channel estimation (e.g., RIS differential channel estimation). The sequence of a set RIS state and an RIS off state may be different in different examples.

CSI-RS modifications (e.g., enhancements) may be made for differential channel estimation as described in one or more examples herein (e.g., to support the differential channel estimation and/or an implementation of the differential channel estimation as described in one or more examples herein). CSI-RS may be used for one or more of beam management, mobility, time-frequency tracking, CSI acquisition, etc. The configuration and transmission possibilities of CSI-RS may cover various uses. CSI-RS(s) may be configured and/or transmitted in various ways in which CSI-RS(s) may be used for one or more of beam management, mobility, time-frequency tracking, CSI acquisition, etc.

For example, a CSI-RS may be used as the pilot for differential channel estimation (e.g., RIS differential channel estimation) and/or CSI acquisition. As described in one or more examples herein, 2M CSI-RS resources may be used, where M may be the number of sub-surfaces (or RIS elements in some cases) and a factor (e.g., the factor 2 here) is corresponding to at least 2 RIS states for differential channel estimation.

The 2M CSI-RS resources may be included in a CSI-RS resource set. The 2M CSI-RS resources may be included in multiple CSI-RS resource sets. The CSI-RS resources may be single-port or multi-port (e.g., dual-port).

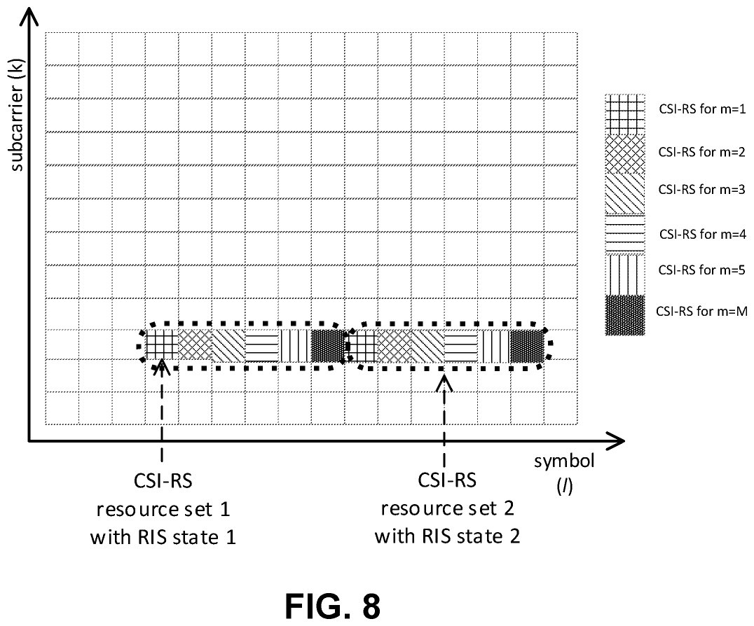

FIG. 8 illustrates an example of CSI-RS resources with two M size resource sets.

The example in FIG. 8 may have CSI-RS resource(s) with the same sub-carrier offset(s). In examples, different resources may have different offsets (e.g., different CSI-RS resources may have different sub-carrier offsets). Different CSI-RS resources may have the same or a different density in frequency, bandwidth, the number of antenna ports, code-division multiplexing (CDM) type, etc. The periodicity of the CSI-RS resources may be the same or different, and the slot offset may be the same or different. In some examples, the CSI-RS resources may not overlap in time on a (e.g., any) symbol, which may be used as a constraint.

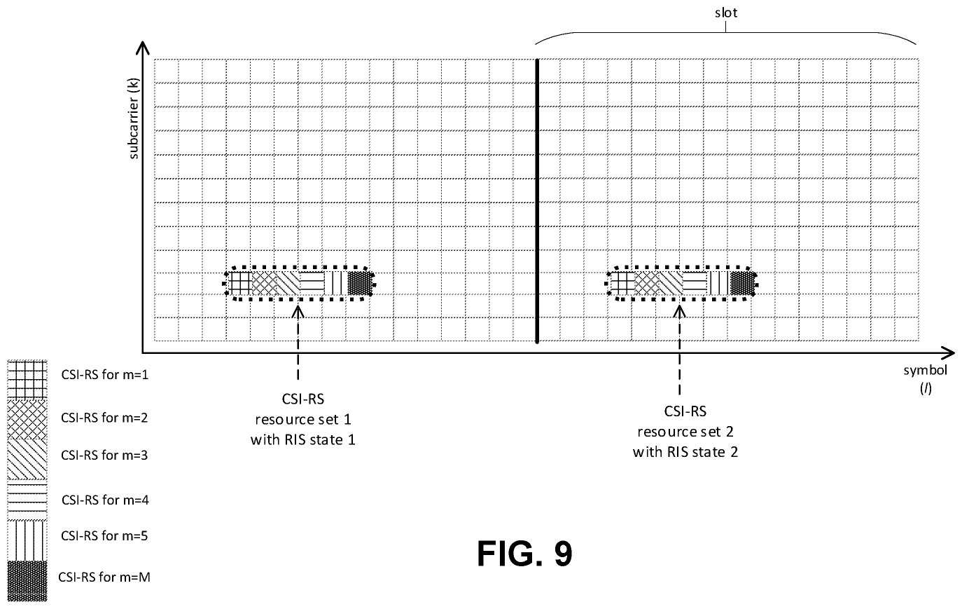

FIG. 9 illustrates an example of CSI-RS resources with resource sets spread in different slots.

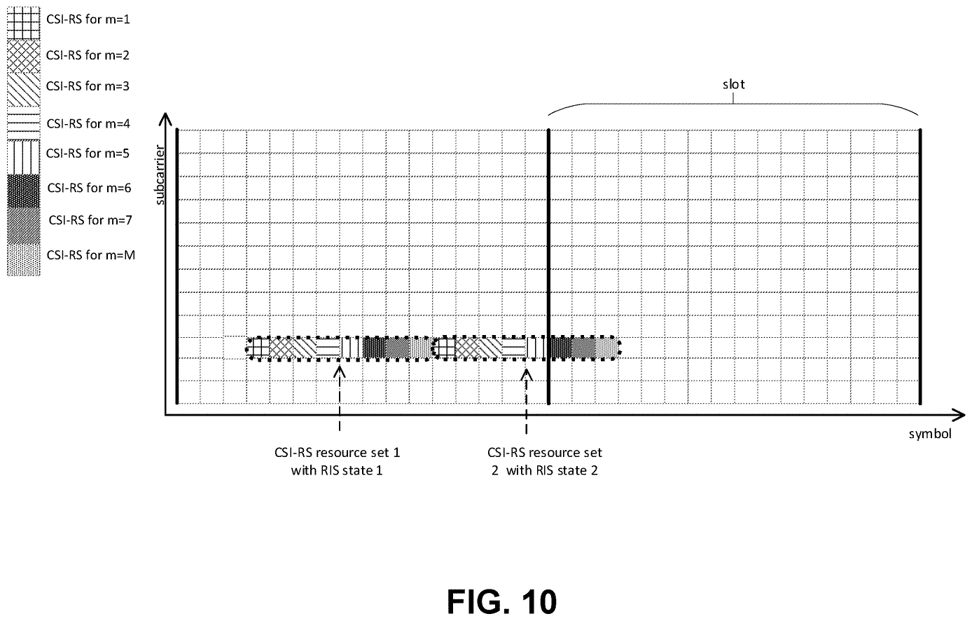

The 2M CSI-RS resources may occur at a similar (not the same) time (e.g., in consecutive symbols, in the same slot (see FIG. 8), in consecutive slots (see FIG. 9), and/or continuously distributed over multiple slots (see FIG. 10), etc.), for example, to enable timely and relevant CSI measurement and reporting.

FIG. 10 illustrates an example of CSI-RS resources occurring in multiple slots.

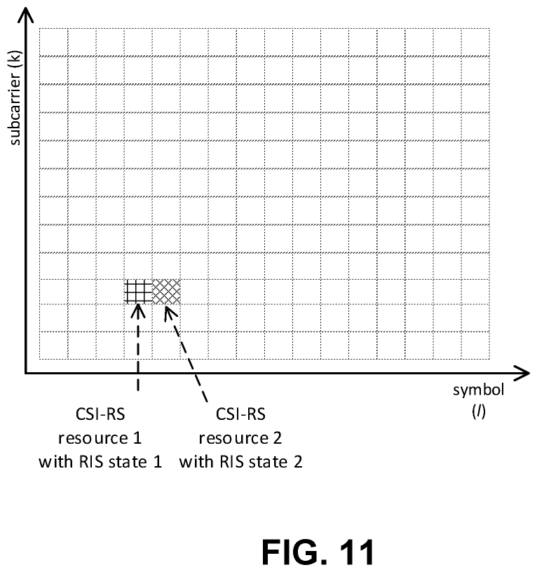

M (e.g., the first M) of the CSI-RS resources may correspond to channel estimation with the RIS state 1 (e.g., per sub-surface (or an RIS element) channel estimation with the RIS state 1), and the other M of the CSI-RS resource may correspond to channel estimation with the RIS state 2 (e.g., per sub-surface (or an RIS element) with RIS state 2). If the sub-surface is the whole RIS, e.g., M=1, the differential channel estimation may be performed by utilizing two CSI-RS resources (e.g., each CSI-RS resource may correspond to a different RIS state as shown in FIG. 11).

FIG. 11 illustrates an example of CSI-RS resources with M=1.

The WTRU may be informed of an association between a CSI-RS resource with an RIS state (e.g., which CSI-RS resource corresponds to which RIS state). For example, when the differential channel estimation is performed at the WTRU, the WTRU may be informed of (e.g., the WTRU may need to know) which CSI-RS resource corresponds to which RIS state. Examples where the CSI-RS resource associated with an RIS state may be determined in a CSI-RS resource set are described in one or more of the following. The CSI-RS resources in a CSI-RS resource set may be configured in a list, e.g., a list of CSI-RS resource IDs. A list (e.g., each list entry) may be associated with the corresponding RIS state (e.g., a first list entry may be for RIS state 1 and a second list entry for RIS state 2). The CSI-RS resources in a CSI-RS resource set may have different CSI-RS resource IDs. The RIS state may be associated with CSI-RS resource IDs based on a pre-defined equation (e.g., the even number CSI-RS resource ID may correspond to RIS state 1, and the odd number CSI-RS resource ID may correspond to RIS state 2, for example as illustrated in FIG. 11). For example, the WTRU may determine, based on received configuration information, a first list of CSI-RS resource IDs and a second list of CSI-RS resource IDs. The first list may be associated with a first RIS configuration. The second list may be associated with a second RIS configuration. The WTRU may determine a first set of CSI-RS resources based on the first list of CSI-RS resource IDs. A first CSI-RS may be received using one or more CSI-RS resources of the first set. The WTRU may determine a second set of CSI-RS resources based on the second list of CSI-RS resource IDs. A second CSI-RS may be received using one or more CSI-RS resources of the second set.

The one or more resource set(s) including the M CSI-RS resources may be included (e.g., by their IDs) in a CSI-RS resource setting (e.g., in the IE CSI-ResourceConfig). A CSI-RS resource setting may include a list of CSI-RS resource sets, e.g., for differential channel measurement and/or estimation. The list may include a sequence of CSI-RS resource set IDs of the CSI-RS resource sets, which may be configured (e.g., configured elsewhere, for example, preconfigured).

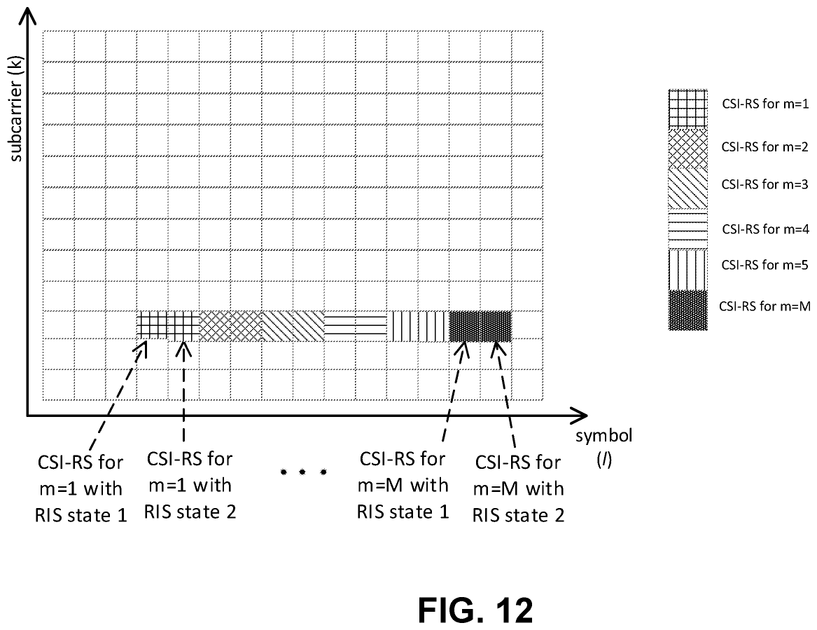

The WTRU may not be aware of the presence of an RIS in the network and may perform CSI measurements (e.g., using the CSI-RSs associated with different RIS states). In examples, when the WTRU is unaware of the presence of an RIS in the network, the WTRU may measure the CSI corresponding to two RIS states that are utilized (e.g., using the CSI-RSs associated with different RIS states) and/or report, to the BS, the CSI corresponding to two RIS states that are utilized. Based on the received CSI (e.g., the received CSI reports by the WTRU), the BS may perform the differential channel estimation using the examples as shown in one or more of FIG. 8, FIG. 9, FIG. 10, FIG. 11, and FIG. 12 (e.g., using CSI-RS enhancements similar to the examples as shown in one or more of FIG. 8, FIG. 9, FIG. 10, FIG. 11, and FIG. 12). The WTRU may not know (e.g., may not need to know) the RIS state that is utilized. FIG. 12 illustrates an example of CSI-RS resource(s) with RIS state(s).

Changes to CSI report (e.g., CSI report enhancements) are described in one or more examples herein. In some examples, during downlink transmission(s), a WTRU may perform measurements and/or CSI acquisition by utilizing the received pilot/reference signals transmitted by a BS (e.g., the gNB). Based on these measurements, in a case of transmissions in frequency-division duplexing (FDD), the WTRU may report (e.g., explicitly or implicitly) the quality of a channel by explicitly transmitting the CSI, e.g., as channel coefficients, and/or implicitly, in the form of the CSI reports, e.g., RI, PMI, CQI etc. When transmissions occur in time-division duplexing (TDD), the BS may exploit the reciprocity of the communication channel and obtain the channel estimates itself. The BS may use the CSI reports and/or channel estimates to adjust/update the system parameters, including one or more of the type pf precoder, modulation, code rate etc.

In the RIS-aided communication system, RIS-aided CSI may be used to adjust/update the RIS parameters, e.g., an RIS state and RIS-aided path parameters at a BS (e.g., codebook and precoder selection for BS-RIS-WTRU path). Changes to CSI report (e.g., CSI report enhancements for RIS-aided system) may be used for differential channel estimation.

Changes to CSI report (e.g., features associated with reporting enhancements for differential channel(s) are described in one or more examples herein. In an example of an RIS-aided differential channel, during downlink transmission(s), a WTRU may perform measurements based on the received pilot/reference signals transmitted by the BS (e.g., to acquire differential channel and compute CSI reports). The WTRU may compute CSI reports for the RIS-aided channel path (e.g., conventional CSI reports for an RIS-aided differential channel path that may include RI, PMI, CQI etc.) to indicate the quality of the RIS-aided channel path. The WTRU may communicate the CSI reports for the RIS-aided channel path (e.g., the RIS-aided CSI reports) along with other CIS reports (e.g., legacy CSI reports that include the effect of RIS-aided plus the direct path). The WTRU may communicate the CSI reports for the RIS-aided channel path (e.g., only report the differential CSI reports), e.g., differential PMI, differential RI, etc. In examples, the differential CSI reports may be determined or considered as the difference (e.g., in an indicator such as the RI, the PMI, and/or the COI) between an RIS-aided path and a direct channel path. The differential CSI report(s) may be based on (e.g., a function of) the weighted difference between the PMI determined for the RIS-aided path and the PMI determined for the direct path. The WTRU may indicate the differential CSI reports at the same periodicity, for example, as configured by the network, as the periodicity at which the WTRU indicates other CSI report(s) (e.g., the legacy CSI reports). The WTRU may indicate the differential CSI reports at a different periodicity, for example, as configured by the network, from the periodicity at which the WTRU indicates other CSI report(s) (e.g., the legacy CSI reports). The WTRU may send the differential CSI reports jointly with other CSI report(s) (e.g., the legacy CSI reports). For example, the WTRU may send the differential CSI report(s) jointly with other CSI report(s) by indicating an index associated with the differential CSI report(s) and an index associated with other CSI report(s) (e.g., by indicating a unique index for each of the reports representing the channel link to which a report may correspond to), or by specifying a position wherein the differential CSI report(s) is in the report and a position where the other CSI report(s) is in the report (e.g., a first part of the report may represent a legacy report and a second part of the report may be the differential report, etc.)

In examples, a WTRU may be configured with, e.g., receive via RRC signaling, configuration information that indicates one or more RIS-related parameters (e.g., phase shift(s) and/or amplification gain(s)), corresponding CSI-RS resource(s), and/or other RIS-related configuration parameters (e.g., the number of sub-surfaces or elements in the x- and y-direction of an RIS). The WTRU may be configured with a CSI report configuration indicating one or more reporting parameters corresponding to the type of CSI report (e.g., legacy and/or differential), report periodicity, reporting functions, etc. The WTRU may receive an indication of (e.g., configuration information indicating) a set of CSI-RS resources for a set of RIS states that are configured, for example, at the RIS by one or more of the following: the BS, the RIS controller, the WTRUs in the network, RAN Intelligent controller (RIC), etc. The WTRU may receive CSI-RS resource(s). The WTRU may measure and compute the differential channel, for example, using one or more examples as described herein. The WTRU may report the differential channel report(s), e.g., if the WTRU is configured to do so in a report configuration.

In examples, an RIS may report its capability to the network/RIS controlling node. The RIS may be configured with an element-wise or sub-surface configuration. The RIS may apply a sub-surface configuration, for example, during time instances determined by configuration/activation/indication/triggering. The RIS may receive an RIS-element level RIS state. The RIS may apply an RIS-element level RIS state, for example, during configured time instances determined by configuration/activation/indication/triggering.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU) comprising:
a processor configured to:
receive configuration information associated with a reconfigurable intelligent surface (RIS), wherein the configuration information indicates a first set of RIS parameters associated with a first RIS configuration and a second set of RIS parameters associated with a second RIS configuration;
receive a first channel state information-reference signal (CSI-RS) associated with the first set of RIS parameters;
receive a second CSI-RS associated with the second set of RIS parameters;
determine, based on the first CSI-RS and the second CSI-RS, a differential CSI measurement associated with a base station (BS)-RIS-WTRU channel associated with the WTRU; and
send a CSI report indicating the differential CSI measurement.

17. The WTRU of claim 16, wherein the first RIS configuration corresponds to a first RIS state, and the second RIS configuration corresponds to a second RIS state, and wherein the first set of RIS parameters represents the first RIS state, and the second set of RIS parameters represents the second RIS state.

18. The WTRU of claim 16, wherein the first set of RIS parameters comprises a first phase shift and a first amplification gain, and the second set of RIS parameters comprises a second phase shift and a second amplification gain, and wherein the first phase shift and the second phase shift are different.

19. The WTRU of claim 18, wherein the first amplification gain and the second amplification gain are different.

20. The WTRU of claim 16, wherein the processor is further configured to:
determine a first channel measurement based on the first CSI-RS; and
determine a second channel measurement based on the second CSI-RS, wherein the differential CSI measurement associated with the BS-RIS-WTRU channel is determined based on a difference between the first channel measurement and the second channel measurement.

21. The WTRU of claim 16, wherein the processor is further configured to:
determine, based on configuration information, a first list of CSI-RS resource identifiers (IDs) and a second list of CSI-RS resource IDs, wherein the first list is associated with the first RIS configuration and the second list is associated with the second RIS configuration;
determine a first set of CSI-RS resources based on the first list of CSI-RS resource IDs, wherein the first CSI-RS is received using one or more CSI-RS resources of the first set; and
determine a second set of CSI-RS resources based on the second list of CSI-RS resource IDs, wherein the second CSI-RS is received using one or more CSI-RS resources of the second set.

22. The WTRU of claim 16, wherein the processor is further configured to:
determine, based on the differential CSI measurement, a rank indicator (RI), a precoding matrix indicator (PMI), a channel quality indicator (CQI) associated with the BS-RIS-WTRU channel;
determine an RI, a PMI, and a CQI associated with a BS-WTRU channel between the WTRU and a base station; and
report the RI, PMI, and CQI associated with the BS-RIS-WTRU channel and the RI, PMI, and CQI associated with the BS-WTRU channel.

23. The WTRU of claim 16, wherein the first set of RIS parameters represents a first RIS state of a sub-surface of the RIS, and the second set of RIS parameters represents a second RIS state of the sub-surface of the RIS.

24. The WTRU of claim 16, wherein the configuration information is received from a BS, and the BS-RIS-WTRU channel is a communication path for the BS and the WTRU via the RIS.

25. A method performed by a wireless transmit/receive unit (WTRU) comprising:
receiving configuration information associated with a reconfigurable intelligent surface (RIS), wherein the configuration information indicates a first set of RIS parameters associated with a first RIS configuration and a second set of RIS parameters associated with a second RIS configuration;
receiving a first channel state information-reference signal (CSI-RS) associated with the first set of RIS parameters;
receiving a second CSI-RS associated with the second set of RIS parameters;
determining, based on the first CSI-RS and the second CSI-RS, a differential CSI measurement associated with a base station (BS)-RIS-WTRU channel; and
sending a CSI report indicating the differential CSI measurement.

26. The method of claim 25, wherein the first RIS configuration corresponds to a first RIS state, and the second RIS configuration corresponds to a second RIS state, and wherein the first set of RIS parameters represents the first RIS state, and the second set of RIS parameters represents the second RIS state.

27. The method of claim 25, wherein the first set of RIS parameters comprises a first phase shift and a first amplification gain, and the second set of RIS parameters comprises a second phase shift and a second amplification gain.

28. The method of claim 27, wherein the first phase shift and the second phase shift are different, and the first amplification gain and the second amplification gain are different.

29. The method of claim 25, further comprising:
determining a first channel measurement based on the first CSI-RS; and
determining a second channel measurement based on the second CSI-RS, wherein the differential CSI measurement associated with the BS-RIS-WTRU channel is determined based on a difference between the first channel measurement and the second channel measurement.

30. The method of claim 25, further comprising:
determining, based on received configuration information, a first list of CSI-RS resource identifiers (IDs) and a second list of CSI-RS resource IDs, wherein the first list is associated with the first RIS configuration and the second list is associated with the second RIS configuration;
determining a first set of CSI-RS resources based on the first list of CSI-RS resource IDs, wherein the first CSI-RS is received using one or more CSI-RS resources of the first set; and
determining a second set of CSI-RS resources based on the second list of CSI-RS resource IDs, wherein the second CSI-RS is received using one or more CSI-RS resources of the second set.

31. The method of claim 25, further comprising:
determining, based on the differential CSI measurement, a rank indicator (RI), a precoding matrix indicator (PMI), a channel quality indicator (CQI) associated with the BS-RIS-WTRU channel;
determining an RI, a PMI, and a CQI associated with a BS-WTRU channel between the WTRU and a base station; and
reporting the RI, PMI, and CQI associated with the BS-RIS-WTRU channel and the RI, PMI, and CQI associated with the BS-WTRU channel.

32. The method of claim 25, wherein the configuration information is received from a BS, and the BS-RIS-WTRU channel is a communication path for the BS and the WTRU via the RIS.

33. The method of claim 25, wherein the first set of RIS parameters represents a first RIS state of a sub-surface of the RIS, and the second set of RIS parameters represents a second RIS state of the sub-surface of the RIS.
